(19) United States
(12) Patent Application Publication
(10) Pub. No.: US 2012/0040648 A1
(43) Pub. Date: Feb. 16, 2012

(54) Convenient Electronic Sound Producing Device

(76) Inventors: Edward J. Sceery, Santa Fe, NM (US); Richard Krukar, Albuquerque, NM (US)

(21) Appl. No.: 13/220,551

(22) Filed: Aug. 29, 2011

Related U.S. Application Data
(63) Continuation-in-part of application No. 11/652,328, filed on Jan. 11, 2007.
Application No. 11/652,328 is a continuation-in-part of application No. 13/113,050, filed on May 21, 2011.

(51) Int. Cl. H04W 88/02; G06F 17/00

(52) U.S. Cl. 455/414.1; 700/94

(57) ABSTRACT

A convenient electronic sound producing device is an electronic sound producing device that is physically configured to be easy to use in the field. A control module faces the use while the sound is projected away from the user. A pistol grip can be used to ease holding and using the call. A remote can further ease operation and allow control from a distance. A timer allows for nearly autonomous operation. Control modules can be fixed to a firearm, bow, crossbow, or camera to minimize the user's movement while simultaneously calling and preparing for a shot. A pinning hole or a stake can allow for reliably fixing the sound producing device to a surface, to vegetation, or to other objects.

### CROSS REFERENCE TO RELATED APPLICATIONS

This patent application is a continuation-in-part of and claims priority and benefit of U.S. patent application Ser. No. 11/652,328 filed on Jan. 11, 2007 entitled “Convenient Electronic Sound Producing Device”, and of U.S. patent application Ser. No. 13/113,050 filed on May 21, 2011 entitled “Cell Phone Based Sound Production” and which both are incorporated herein by reference in their entirety.

### TECHNICAL FIELD

Embodiments relate to sound producing devices, digital audio devices, remote controls, cellular telephones, communications networks, and data servers. Embodiments also relate to hunting, wildlife observation, and wildlife vocalizations.

### BACKGROUND OF THE INVENTION

People have made and used sound producing devices to produce sounds since prehistoric times and continue to make and use them. Sounds are produced for a variety of reasons. Call sounds are sounds whose purpose is to imitate an animal. Certain sounds can entice an animal to respond and sometimes to come closer. Other sounds are enjoyable to humans and can invoke a human response. Over time, sound production technology has changed while the purposes have largely remained the same.

A person uses a sound producing device to produce a sound. In general, the sound is an attractive sound such as an imitation of an animal vocalization. Different sounds are appropriate for enticing different responses. For example, elk can respond to any of a variety of elk vocalizations or other attractive sounds such as antlers thrashing in brush. Similarly, turkey can respond to any of a variety of turkey vocalizations or other attractive sounds such as beating wings. Predators, such as coyotes, often respond to prey animal vocalizations such as those of a distressed rabbit.

Electronic sound producing devices are devices that are readily available from a variety of manufacturers. These devices can store digitized game animal vocalizations and other sounds. Electronic sound producing devices, however, are additional pieces of equipment that must be carried or bought. Furthermore, current electronic sound producing devices have cumbersome methods at best for obtaining and storing new sounds. A need therefore exists for an easily loaded and carried electronic sound producing device.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

It is therefore an aspect of the embodiments for a sound producing module to play a call sound on a speaker. A user can operated a control module to select what sound or sounds to play and can operate an actuator to cause the sound to actually be played.

It is also an aspect of the embodiments the call sounds can be obtained from a remote server. Furthermore, recovery information can be generated such that lost sounds can be recovered. Lost sounds are sounds that were stored in the non-volatile memory but have become lost due to malfunction, error, or some other event.

It is also an aspect of various embodiments that a cell phone can obtain the call sounds from a remote server. A presentation on the cell phone display offers the user a number of available call sounds. The user can select one to thereby cause it to be downloaded and become playable as one of the stored call sounds. In some embodiments the cell phone can also be used to select what sound is to be played and to trigger the playing of that sound.

It is an aspect of certain embodiments to have a remote controller attached to a weapon such that the user can operate the electronic game call without letting go of the weapon.

It is also another aspect of the embodiments that a sound producing module accesses the stored call sounds and plays them on a speaker. The speaker can be an internal speaker that is part of the electronic device or can be an external speaker that is not. External speakers receive signals from the electronic device and use them to produce sound. Signals can be transmitted using wires, wirelessly using electromagnetic radiation, or in some other way.

### BRIEF DESCRIPTION OF THE DRAWINGS

The accompanying figures, in which like reference numerals refer to identical or functionally similar elements throughout the separate views and which are incorporated in and form a part of the specification, further illustrate aspects of the embodiments and, together with the background, brief summary, and detailed description serve to explain the principles of the embodiments.

FIG. 1 illustrates a sound producing device in accordance with aspects of the embodiments;

FIG. 2 illustrates a user using a sound producing device in accordance with aspects of the embodiments;

FIG. 3 illustrates a control module in accordance with aspects of the embodiments;

FIG. 4 illustrates a base in accordance with aspects of the embodiments;

FIG. 5 illustrates speaker ports in a housing in accordance with aspects of the embodiments;

FIG. 6 illustrates a remote in accordance with aspects of some embodiments;

FIG. 7 illustrates a high level block diagram of a sound producing device in accordance with aspects of the embodiments;

FIG. 8 illustrates a firearm configured for use with a sound producing device in accordance with aspects of certain embodiments;

FIG. 9 illustrates a side view of using a hook in a pinning hole in accordance with aspects of some embodiments; and

FIG. 10 illustrates a front view of using a hook in a pinning hole in accordance with aspects of some embodiments.

FIG. 11 illustrates a cell phone adapted for use as a sound producing device in accordance with aspects of the embodiments;

FIG. 12 illustrates a high level block diagram of a cell phone adapted for use as a sound producing device in accordance with aspects of the embodiments;

FIG. 13 illustrates a high level block diagram of an electronic sound producing device in accordance with aspects of the embodiments;

FIG. 14 illustrates available sounds in accordance with aspects of the embodiments;

FIG. 15 illustrates a high level block diagram of obtaining and playing a sound in accordance with aspects of the embodiments;

FIG. 16 illustrates a high level block diagram of using an inactivated cell phone as an electronic sound producing device in accordance with aspects of the embodiments; and

FIG. 17 illustrates shifting a sound in pitch and tempo in accordance with aspects of the embodiments.

### DETAILED DESCRIPTION

The particular values and configurations discussed in these non-limiting examples can be varied and are cited merely to illustrate at least one embodiment and are not intended to limit the scope thereof. In general, the figures are not to scale.

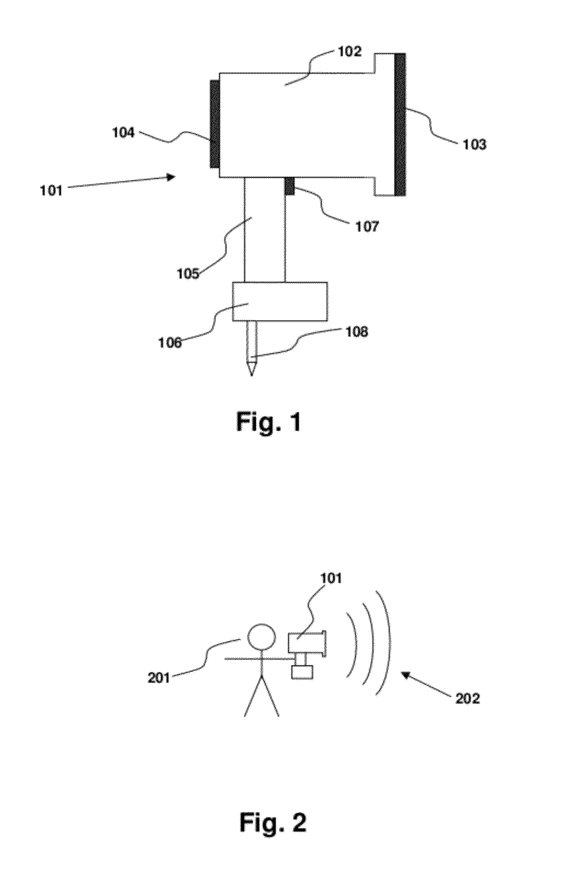

FIG. 1 illustrates a sound producing device 101 in accordance with aspects of the embodiments. A housing 102 has a control module 104 mounted in back and a speaker 103 mounted in front. The housing 102 is illustrated as having a pistol grip 105 and a base 106. A trigger type actuator 107 is mounted to the housing 102 such that a user holding the pistol grip 105 can squeeze it. A deployable spike 108 is shown extending from the bottom of the base. The deployable spike 108 is not fixed in place but can be removed. In some embodiments, the deployable spike 108 can be stored within the housing 102 and can be deployed by a user. The deployable spike 108 is used to fix the sound producing device 101 in place. For example, the deployable spike 108 can be driven into the ground so that the sound producing device 101 is fixed in place on the ground.

FIG. 2 illustrates a user 201 using a sound producing device 101 in accordance with aspects of the embodiments. The user 201 is holding the pistol grip and squeezing the actuator. The sound producing device 101 is producing a call sound 202. Notice that the user 201 is looking at the control module on the back of the housing and that the call sound is emitted from the front of the housing. A spike such as that illustrated in FIG. 1 is not illustrated as deployed in FIG. 2.

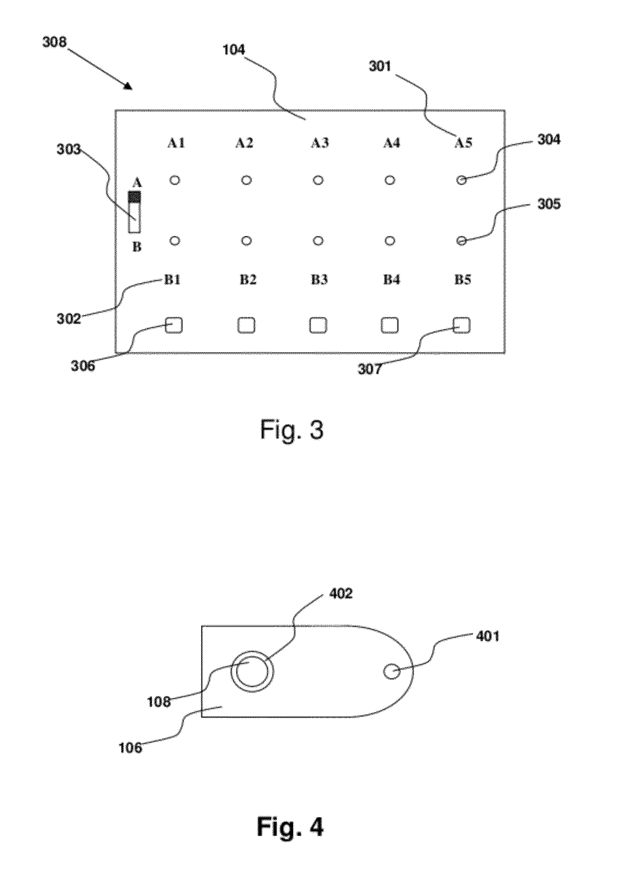

FIG. 3 illustrates a control module 104 in accordance with aspects of the embodiments. The control module 104 has a control layout 308 that specifies the positions of labels, indicators, and buttons. As such, the control module 104 has two label rows, each row having five labels. The control module 104 also has two indicator rows, each having five indicators. The top label row has labels such as “A5” 301. The labels used are intended to indicate where labels can be positioned. In practice, the labels can be “coyote howl”, “distressed rabbit”, “cat howl”, or any other call name. The top indicator row has indicators such as the “A5” indicator 304. A light emitting diode (LED) can be used as an indicator. The lower label row is illustrated as positioned under the lower indicator row and containing labels such as “B1”. The lower indicator row contains indicators such as the “B5” indicator 305.

A selector row can contain buttons such as the leftmost button 306. A bank selector 303 can be used to select the top row or the bottom row. The bank selector 303 is illustrated as selecting the top row. Pressing the rightmost button 307 with the bank selector 303 in the top position selects call sound “A5” and the “A5” indicator 301 lights up.

Multifunction indicators, such as multifunction LEDs can also be used. A multifunction LED can display two or more colors. For example, a control module can have two label rows and a multifunction LED row. In this case the “A5” indicator 304 becomes the “A5/B5” indicator 304 and the “B5” indicator does not exist. A red “A5/B5” indictor 304 can indicate that call sound “A5” is selected whereas a green “A5/B5” indictor 304 can indicate that call sound “B5” is selected.

FIG. 4 illustrates a base 106 in accordance with aspects of the embodiments. The deployable spike 108 is illustrated mounted in a spike hole 402 in the base. A pinning hole 401 in the base 106 can be used in a number of ways. The pinning hole 401 can be used to hang the sound producing device from a tree branch, in which case the sound producing device would be up side down. A nail or pin through the pinning hole 401 can fix the sound producing device to another object, such as a tree or the ground. A cord can be threaded through the pinning hole 401 and tied to something or used to hang the sound producing device from a tree branch.

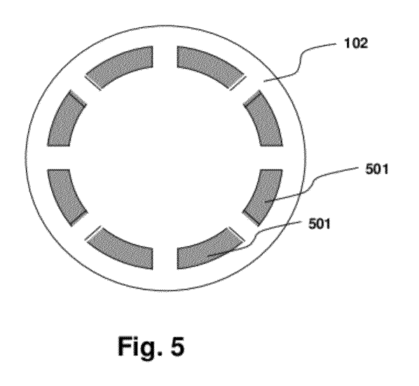

FIG. 5 illustrates speaker ports 501 in a housing 102 in accordance with aspects of the embodiments. Those practiced in the arts of acoustics or speaker enclosures are familiar with systems and methods for using speaker ports to improve the sound of a speaker.

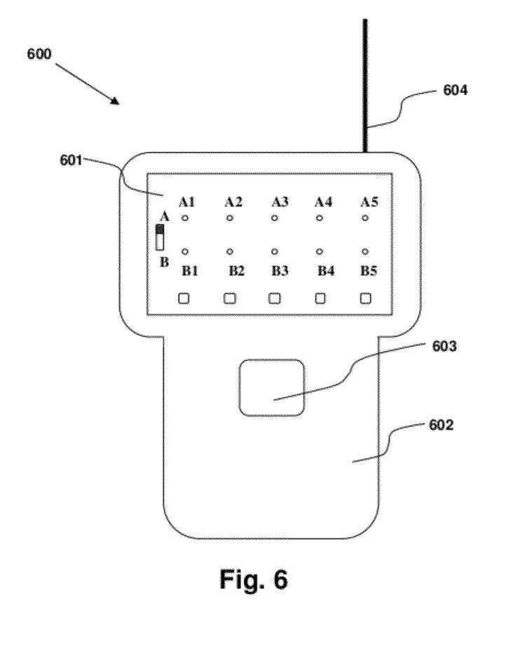

FIG. 6 illustrates a remote 600 in accordance with aspects of some embodiments. The remote 600 has a remote housing 602 and a remote control module 601. Notice that the remote control module 601 and the control module illustrated in FIG. 3 have the same configuration of labels, indicators, selectors, and bank selector. It is advantageous for the control module and the remote control module 601 to look the same and be operated the same because a user who can use one can immediately use the other without additional instruction. The remote 600 also has a remote actuator 603.

The remote 600 can communicate with the sound producing device such that remote operations are equivalent to directly operating the sound producing device. For example, pressing the remote actuator can cause a remote output signal corresponding to actuation to be sent to the sound producing device that then reacts as if the actuator was pulled. Similarly, selecting a call remotely can cause a remote output signal corresponding to call selection to be sent to the sound producing device that then reacts as if the control module were used to select a call. For example, a user can select call “A4” on the remote 600. The remote's “A4” indicator is lit in response and a remote output signal is transmitted. The sound producing device receives the remote output signal, selects the “A4” call, and lights the sound producing device's “A4” indicator. If the sound producing device plays a call sound on selection, then the sound producing device can also play a call sound on remote selection.

The placement of the control module on the back of the sound producing device allows the user to observe it from a distance while directing call sounds in a forward direction. In practice, a user can position the sound producing device and then move back from it. The user can remotely select calls and see the reaction on the control module. As such, the user is confident that remote operation is working reliably.

The sound producing device and the remote can be kept in synchronization if the sound producing device can send a call output signal to the remote. One example of synchronization is that when a user selects a call sound on the remote, the remote sends a remote output signal to the sound producing device. The sound producing device responds by selecting the desired call sound, lighting the appropriate indicator on the control module, and sending a call output signal to the remote. The remote responds by lighting the appropriate indicator on the remote control module. A second example is when the user uses the control module to select a call sound. The sound producing device responds by lighting the appropriate indicator on the control module and sending a call output signal to the remote. The remote responds by lighting the appropriate indicator on the remote control module.

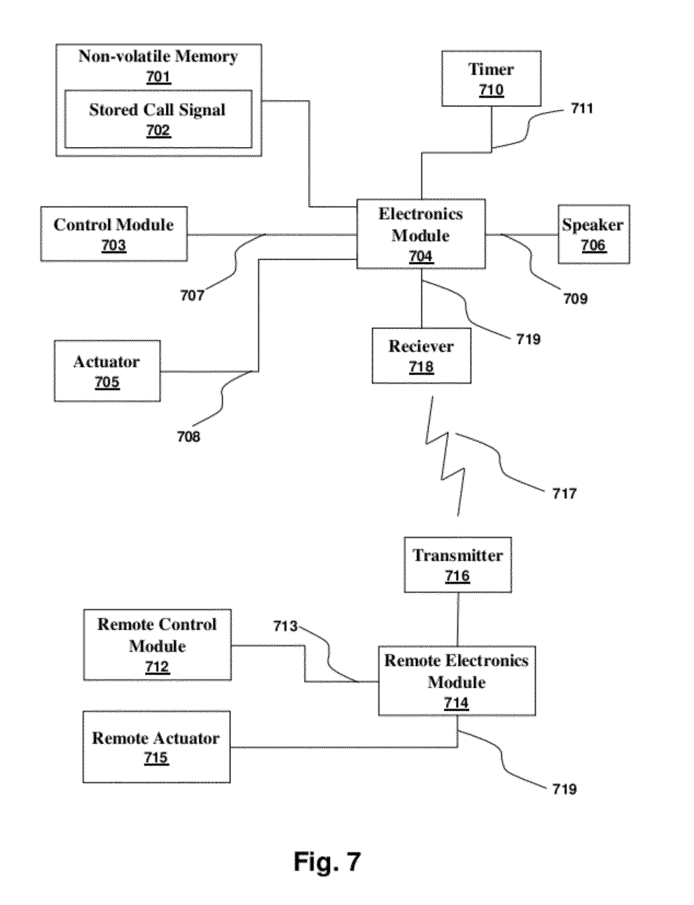

FIG. 7 illustrates a high level block diagram of a sound producing device in accordance with aspects of the embodiments. Non-volatile memory 701, such as a flash memory, read only memory, or magnetic disk can contain at least one stored call signal 702. An electronics module 704 can access the stored call signal 702. A control module 703 and the electronics module 704 use control signals 707 to communicate. An actuator 705 sends an actuation signal 708 to the electronics module 704. The electronics module 704 obtains one of the possibly many stored call signals 702 based on the control signals 707. On receiving the actuation signal 708, the electronics module 704 sends a call signal 709 to the speaker 706. The speaker 706 then produces a call sound.

A timer 710 can be used to trigger periodic call sounds. The user can use a timer control interface on the control module 703 or remote control module 712 to select a time interval. Those practiced in setting alarm clocks, cooking timers, watches, or similar devices are familiar with timer control interfaces. The timer 710 can repeatedly produce a timed actuation signal 711 each time the time interval elapses. As such, the timer can count down until the time interval ends and then automatically reset and begin counting down again. The electronics module reacts to the timed actuation signal by sending the call signal 709 to the speaker 706.

A remote can contain a remote control module 712, transmitter 716, and remote electronics module 714. The remote control module 712 and the remote electronics module 714 can use remote electronic module inputs 713 to communicate. The remote electronics module 714 then sends a remote output signal to a remote communicator 716, such as a radio, that transmits it to a call communicator 718 from which the remote output signal goes to the electronics module 704. As such, the electronics module 704 can react to the remote control module 712 in the same way it would react to the control module 703. Similarly, a remote actuator 715 sends a remote actuation signal 719 to the remote electronics module 714 such that, eventually, the electronics module 704 reacts by producing the call signal 709.

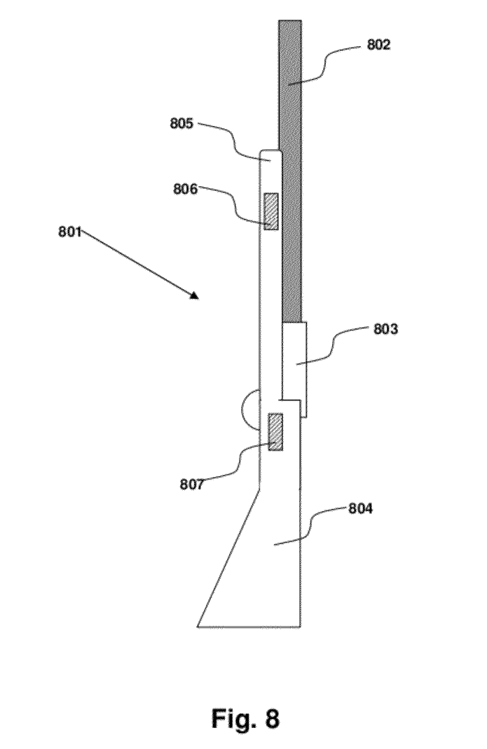

FIG. 8 illustrates a firearm 801 configured for use with a sound producing device in accordance with aspects of certain embodiments. The firearm 801 has a barrel 802, action 803, and stock 804. A forward interface 806 is attached to the fore stock 805, which is the front part of the stock 804. A back interface 807 is located near the action 803. While aiming the firearm 801, a user can manipulate the forward interface 806 with one hand or the back interface 807 with the other hand. The front interface 806 can have a remote actuator, a remote control module, or both. The back interface 807 can also have a remote actuator, a remote control module, or both. The firearm 801 is illustrated with both a front interface 806 and back interface 807 although in practice only one interface is used. A bow, crossbow, or camera can also be configured with an interface such as the back interface 807 or front interface 806. A fastener, such as glue, adhesive, or Velcro can be used for attaching interface.

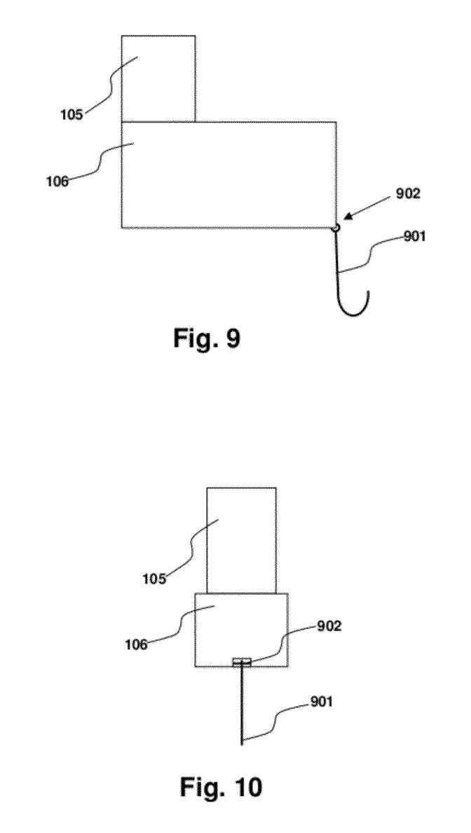

FIG. 9 illustrates a side view of using a hook in a pinning hole in accordance with aspects of some embodiments. The lower portion of a pistol grip 105 is connected to a base having a pinning hole 902. A hook 901 is attached to the pinning hole 902. The sound producing device can be hung by the hook. Other hanging means, such as cords, carabiners, or wire can be used instead of the hook.

FIG. 10 illustrates a front view of using a hook in a pinning hole in accordance with aspects of some embodiments. The lower portion of a pistol grip 105 is connected to a base having a pinning hole 902. A hook 901 is attached to the pinning hole 902. In this embodiment, unlike that illustrated in FIG. 4, the pinning hole 902 does not pass from the top of the base to the bottom of the base. Instead, it passes from the front of the base to the bottom of the base. In other embodiments, the pinning hole can be positioned anywhere on the housing.

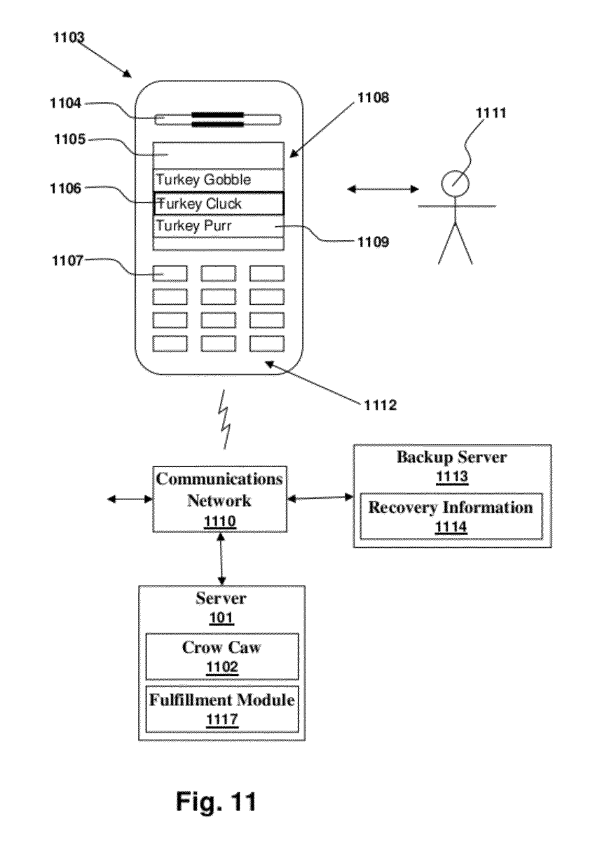

FIG. 11 illustrates a cell phone 1103 adapted for use as a sound producing device in accordance with aspects of the embodiments. The cell phone 1103 is illustrated as having an internal speaker 1104, display 1105, and keypad 1112. The display 1105 is illustrated as showing a presentation 1108 of available sounds such as “Turkey Cluck” 1106 and “Turkey Purr” 1109. “Turkey Cluck” 1106 is also the selected sound as indicated by the heavy outline. The keypad 1112 is a human input device (HID) having keys 1107 that a user 1111 can press. Many cell phones have other HIDs such as joy sticks or touch sensitive displays. Regardless of the HID, the user 1111 can manipulate the HID to navigate the user interface and to select available call sounds.

The cell phone 1103 can use a communications network 1110 to send and receive data from a server 1101. The cell phone 1103 can download a served sound, such as “Crow Caw” 1102 from the server and store it in non-volatile memory. Non-volatile memory is memory that persists after a device is turned off. Storing “Crow Caw” in non-volatile memory creates the “Crow Caw” stored sound.

Non-volatile memory can fail for a number of reasons. For example, the cell phone can catch fire destroying all stored data. A backup server 1113 can be used to recover the stored data. The backup server 1113 can contain recovery information 1114 or the recovery information 1114 can be held elsewhere, perhaps in removable storage. The recovery information 1114 can be used to recover all the sounds that the user 1111 had stored in the cell phone 1103.

Sounds can be free or can be paid for. When they are paid for, the user 1111 can provide information to a payment processor 1115 who uses a payment processing module 1116 to obtain payment. The information often includes an account number, user identifier, and the sound, or sounds, which the user 1111 wants. The payment processor 1115 can then inform a fulfillment module 1117 that the user 1111 is allowed to access the sounds. The user 1111 can then obtain the sounds from the server 1101.

Permission information can be used to prevent or allow the playing of sounds. The permission information can be used to restrict the playable sounds to those obtained from a specific server or provider. For example, a provider can encrypt a sound so that a decryption key is required for playing it. The permission information can restrict playing to a specific device. For example, every cell phone has a unique identifier that can be used to verify that a particular cell phone is allowed to play a particular sound. Another possibility is that a password can be required to unlock a sound. Those familiar with the digital rights management are familiar with permission information.

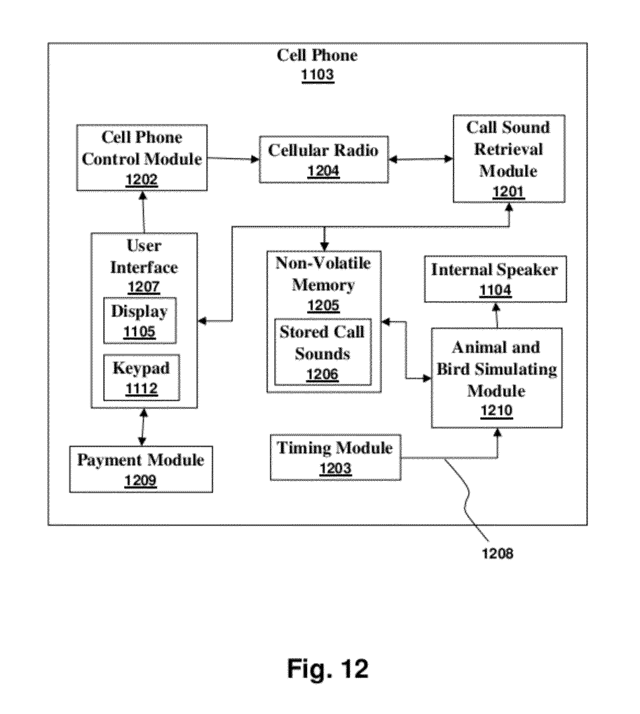

FIG. 12 illustrates a high level block diagram of a cell phone 1103 adapted for use as a sound producing device in accordance with aspects of the embodiments. The cell phone 1103 has a non-volatile memory 1205 for storing stored sounds 1206. The keypad 1112, display 1105, and any other HIDs are part of the user interface 1207. The cell phone uses a cellular radio 1204 to communicate with the communications network. The user interface 1207 is used to select available sounds and the sound retrieval module 1201 can use the cellular radio 1204 to help obtain served sounds from a server. A sound producing module 1210 can access the stored sounds 1206 and play them on a speaker 1210.

The sound producing module 1210 can play a sound when a key is pressed, upon receiving a timed actuation signal 1208, or upon some other event. A timing module 1203 can produce the timed actuation signal 1208. A timed actuation signal can be periodic or can occur once after a time period elapses.

The cell phone 1103 can also contain a payment module 1209 and a cell phone control module 1202. The payment module 1209 interacts with the payment processing module of FIG. 11 to facilitate payment. The cell phone control module 1202 can shut down and restart the cellular radio 1204. Shutting down the cellular radio 1204 conserves energy while using the cell phone 1103 as a sound producing device. The reason is that being outside the range of the communications network makes the cellular radio 1204 useless. Furthermore, many cell phones go into a power consumptive mode when searching for a communications network or when barely in range of a communications network.

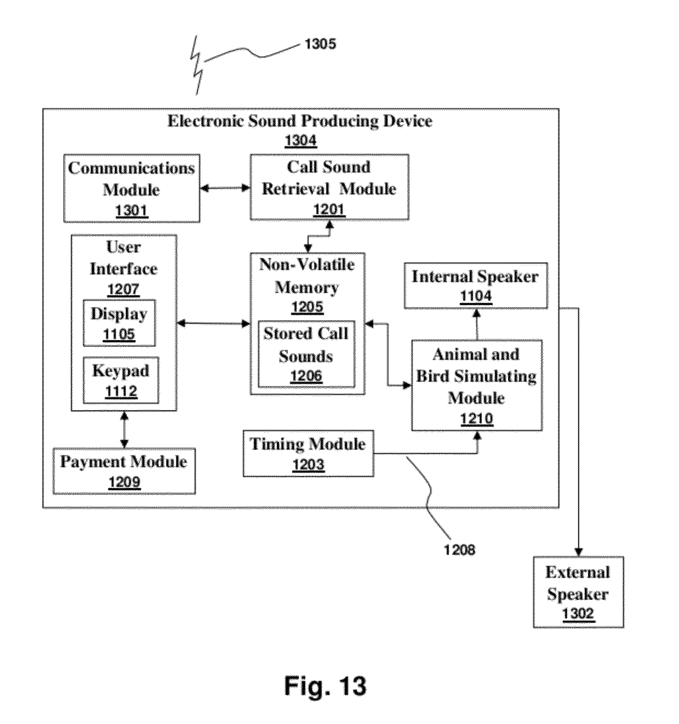

FIG. 13 illustrates a high level block diagram of an electronic sound producing device 1304 in accordance with aspects of the embodiments. The electronic sound producing device 1304 has many of the same components as the cell phone of FIGS. 11 and 12. However, a communications module 1301 takes the place of the cellular radio. A remote actuator 1303 is illustrated sending a remote actuation signal 1305 that can trigger the sound producing module 1210 to play the selected call sound. The sound producing module 1210 can play the call sound on an external speaker 1302. The external speaker can have a wired or wireless connection to the electronic sound producing device 1304.

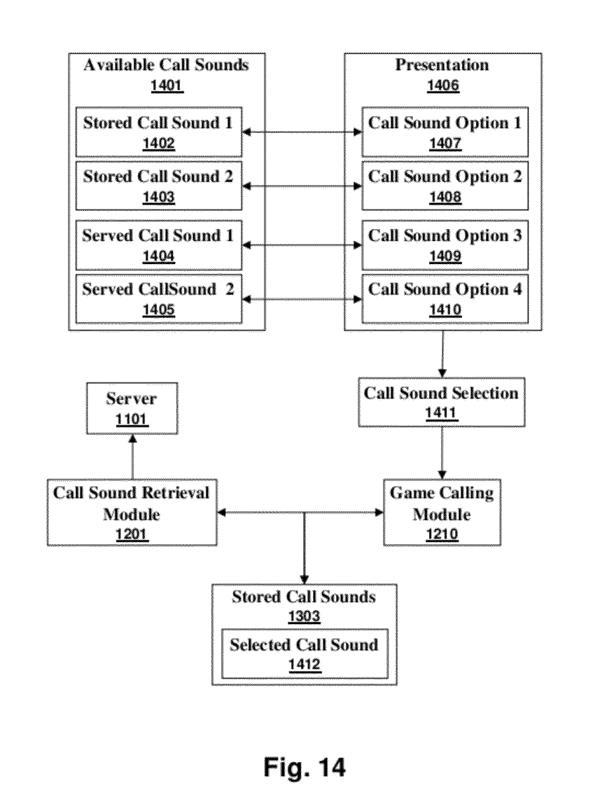

FIG. 14 illustrates available sounds 1401 in accordance with aspects of the embodiments. Stored sound 1 1402 and stored sound 2 1403 are in the non-volatile memory while served sound 1 1404 and served sound 2 1405 are on a server. All four sounds are available because the sound retrieval module can obtain the served sounds and store them. A presentation 1406 presents a user with available sounds. Available sound 1 1407 corresponds to stored sound 1 1402. Available sound 2 1408 corresponds to stored sound 2 1403. Available sound 3 1409 corresponds to served sound 1 1404. Available sound 4 1410 corresponds to served sound 2 1405.

The user selects one of the available sounds as the sound selection 1411. The sound selection 1411 corresponds to the selected sound 1412 that is also one of the available sounds 1401. The sound selection is communicated to the sound producing module 1207. If the selected sound 1412 is not among the stored sounds 1303, then the sound retrieval module 1201 can obtain it from the server 1101 and store it. The game calling module 1210 can play the selected sound 1412.

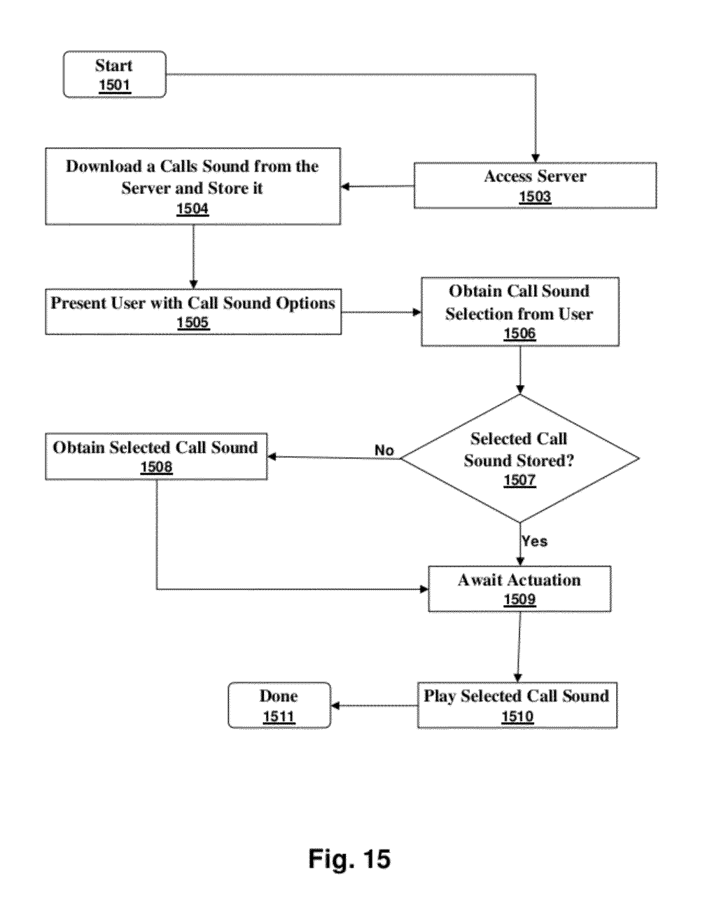

FIG. 15 illustrates a high level block diagram of obtaining and playing a sound in accordance with aspects of the embodiments. After the start 1501, the server is accessed 1503 and call sounds downloaded for storage 1504. The user is presented with the available sounds 1505 and makes a sound selection 1506. If the selected sound is not stored 1507, then it must be obtained 1508 from the server. Once the selected is stored, an actuation signal can be waited for 1509. On receiving the actuation signal, the selected sound is played 1510 and the process is done 1511.

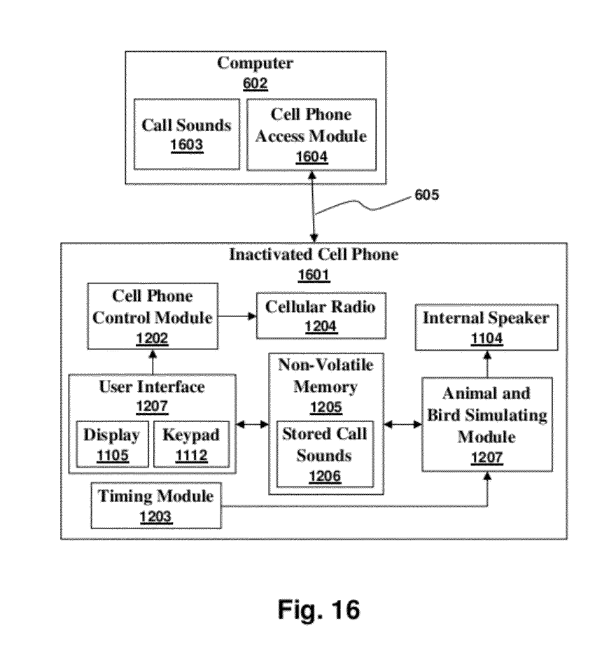

FIG. 16 illustrates a high level block diagram of using an inactivated cell phone 1601 as an electronic sound producing device in accordance with aspects of the embodiments. A cell phone, such as that illustrated in FIG. 12, can be inactivated by removing its association with a cellular network. For example, people often upgrade their cell phones and end up with an old cell phone that is inactivated. They cannot use the old cell phone to make calls or to access the cellular network because it is inactivated. An Inactivated cell phone 1601 can have a functioning cellular radio, but the cellular network ignores it. As such, the cellular radio merely wastes power.

The inactivated cell phone 1601 can function as an electronic sound producing device similar to the cell phone 1103 of FIG. 2 with a few exceptions. The inactivated cell phone cannot use the cellular radio to connect to a server and obtain additional sounds. Call sounds can, however, be obtained from a computer 1602 with access to sounds 1603. Most cell phones, inactivated or not, can be connected to a computer by a link 1605. Some links are wired and others, such as Bluetooth links, are wireless. Most computers require a cell phone access module 1604 in order to access the data and modules within a cell phone. Regardless, the computer 1602 can place stored sounds 1206 into a cell phone. In fact, a computer 1602 can configure an inactivated cell phone 1601 as an electronic sound producing device by downloading all the required sounds and modules. As such, a useless inactivated cell phone can be recycled to produce an electronic sound producing device.

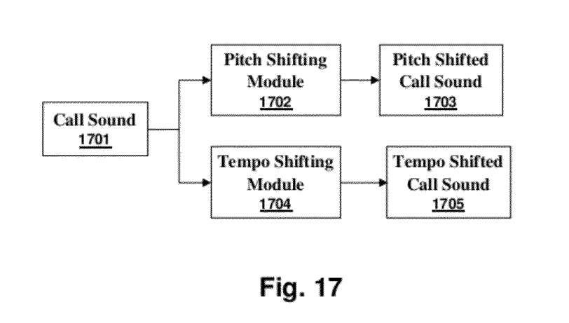

FIG. 17 illustrates shifting a sound 1701 in pitch and tempo in accordance with aspects of the embodiments. A sound 1701 passing through a pitch shifting module 1702 results in a pitch shifted sound 1703. Passing a sound 1701 through a tempo shifting module 1704 results in a tempo shifted call sound 1705. Those practiced in the art of signal processing are familiar with techniques for shifting a signal's pitch or tempo.

Pitch can be shifted by modulation or by using a Fourier transform algorithm to obtain the signals spectrum. The spectrum can then simply be moved in the frequency domain and then converted back into a temporal signal. Tempo can be altered by adding or deleting sample points in the signal's digital waveform. Resampling can also be used for changing tempo. Sound engineers in the music industry often use signal processing packages to manipulate music. Pitch shifting modules, tempo shifting, and resampling modules are among the most basic modules within a modern signal processing package.

As anyone who has played a phonographic record or an analog magnetic tape at the wrong speed knows, shifting tempo can cause an induced pitch change. As such, pitch shifting modules are often used to correct for the induced pitch change.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system comprising:
an first speaker within a housing wherein the first speaker is one of at least one speaker;
a cell phone comprising an input device, a display, a cellular radio, an internal speaker and a non-volatile memory wherein a plurality of stored sounds are stored in the non-volatile memory;
a control module fixed to the housing wherein a user manipulates the control module to choose a selected sound from amongst the stored call sounds;
a sound producing module within the housing and that accesses the stored call sounds to thereby play the selected sound on at least one of the at least one speaker;
an actuator wherein a user operates the actuator to trigger the playing of the selected sound;
a presentation displayed on the display that offers a plurality of served call sounds from which the user selects a desired call sound;
a sound retrieval module that downloads the desired call sound from a server and wherein the sound retrieval module stores the desired call sound in the non-volatile memory such that the desired call sound becomes one of the stored call sounds.

2. The system of claim B1 further comprising a local non-volatile memory within the housing and wherein a plurality of the stored call sounds are stored in the local non-volatile memory.

3. The system of claim B2 further comprising a synchronization module the synchronizes the non-volatile memory and the local non-volatile memory.

4. The system of claim 1 further comprising:
a remote controller wherein the user manipulates the remote to choose the selected sound and to remote trigger the playing the selected sound on the speaker.

5. The system of claim 1 wherein the user manipulates the cell phone to choose the selected sound and to remotely trigger the playing of the selected sound on one of the at least one speaker.

6. The system of claim 1 further comprising a timer that produces a timed actuation signal that triggers the sound producing module to produce the call signal.

7. The system of claim 1 further comprising an external speaker that is yet another one of the at least one speaker.

8. The system of claim 1 further comprising a payment module wherein the payment module to tenders a payment to a payment processor to thereby obtain access to the served sound.

9. The system of claim 1 further comprising a weapon attachment that attaches the remote to a weapon.

10. The system of claim B1 further comprising:
a local non-volatile memory within the housing and wherein a plurality of the stored call sounds are stored in the local non-volatile memory;
a synchronization module the synchronizes the non-volatile memory and the local non-volatile memory;
a remote controller wherein the user manipulates the remote controller to choose the selected sound and to remotely trigger the playing the selected sound on the speaker.
a timer that produces a timed actuation signal that triggers the sound producing module to produce the call signal;
an external speaker that is yet another one of the at least one speaker;
a payment module wherein the payment module to tenders a payment to a payment processor to thereby obtain access to the served sound; and
a weapon attachment that attaches the remote to a weapon.

11. A system comprising:
an internal speaker within a housing wherein the internal speaker is one of at least one speaker;
a non-volatile memory within the housing wherein a plurality of stored call sounds are stored in the non-volatile memory;
a control module fixed to the housing wherein a user manipulates the control module to choose a selected sound from amongst the stored call sounds;
a sound producing module within the housing and that accesses the stored call sounds to thereby play the selected sound on at least one of the at least one speaker;
an actuator wherein a user operates the actuator to trigger the playing of the selected sound;
a presentation that offers a plurality of served call sounds from which the user selects a desired call sound;
a sound retrieval module that downloads the served call sound from a server and wherein the sound retrieval module stores the served call sound in the non-volatile memory such that the served call sound becomes one of the stored call sounds.

12. The system of claim 11 further comprising recovery information for recovering lost call sounds wherein certain of the stored call sounds are lost to thereby become lost sounds.

13. The system of claim 11 further comprising:
a remote controller wherein the user manipulates the remote to choose the selected sound and to trigger the playing the selected sound on the speaker.

14. The system of claim 11 further comprising a timer that produces a timed actuation signal that triggers the sound producing module to produce the call signal.

15. The system of claim 11 further comprising an external speaker that is one of the at least one speaker.

16. The system of claim 11 further comprising a payment module wherein the payment module to tenders a payment to a payment processor to thereby obtain access to the served sound.

17. The system of claim 11 further comprising a weapon attachment that attaches the remote to a weapon.

18. A system comprising:
a server that offers a plurality of served call sounds to a user of an electronic game call wherein the user selects one of the served call sounds to be a selected call sound, wherein a sound retrieval module retrieves the selected call sound from the server and stores the selected sound in a non-volatile memory as one of a plurality of stored call sounds and wherein the user operates the electronic game call to thereby play the stored sounds from a speaker; and
recovery information for recovering lost sounds for the user wherein the user has lost certain of the stored sounds that thereby become lost sounds.

19. The system of claim 18 further comprising a payment processing module and a fulfillment module wherein the cell phone is allowed to obtain the selected sound from the fulfillment module only after a corresponding payment to the payment processing module.

20. The system of claim 18 further comprising permission information that restricts the playing of a sound obtained from the server to a particular cell phone.
